(19) United States
(12) Patent Application Publication
(10) Pub. No.: US 2026/0322040 A1
(43) Pub. Date: Oct. 15, 2026

(54) ELECTRICAL CONNECTOR

(71) Applicant: I-PEX Inc., Kyoto-shi (JP)

(72) Inventor: Seiya SHIGEKOSHI, Ogori-shi (JP)

(21) Appl. No.: 19/639,043

(22) Filed: Apr. 3, 2026

(30) Foreign Application Priority Data
Apr. 10, 2025 (JP) 2025-064714
Feb. 4, 2026 (JP) 2026-017168

(51) Int. Cl. H01R 13/6581; H01R 12/71

(52) U.S. Cl. CPC H01R 13/6581; H01R 12/716

(57) ABSTRACT

An electrical connector includes an electrically conductive cover member that is movably attached to a shell member between a first position that allows a board connection portion of at least one contact member to be visually recognized through an opening, and a second position that prevents the board connection portion of the at least one contact member from being visually recognized through the opening.

### CROSS-REFERENCE TO RELATED APPLICATIONS

This application claims the benefit of Japanese Patent Application No. 2025-64714, filed on Apr. 10, 2025, and Japanese Patent Application No. 2026-017168, filed on Feb. 04, 2026, the entire disclosures of which are incorporated by reference herein.

### FIELD OF THE INVENTION

This application relates generally to an electrical connector.

### BACKGROUND OF THE INVENTION

Patent Literature 1 (Chinese Utility Model No. 217956286) discloses a board connector that shields electromagnetic waves radiated from a plate-shaped connection object (a card). In this board connector, a conductive shell covers most of an insulating housing that holds conductive contacts including a connection portion (a portion connectable to a board) of each contact.

In the above-described board connector disclosed in Patent Literature 1, since the shell covers the connection portions of the contacts as described above, it is difficult to visually recognize, for example, whether the contacts are properly soldered to the board.

The present disclosure has been made in view of the above-described circumstances, and an objective of the present disclosure is to provide an electrical connector that allows a connection state between a board and contact members (contacts) to be confirmed by visual inspection or the like without impairing a function of shielding electromagnetic waves.

### SUMMARY OF THE INVENTION

In order to achieve the above-described objective, an electrical connector according to the present disclosure is an electrical connector to be mounted on a board, and the electrical connector includes:
an insulating housing member including a slot into which a flat plate-shaped connection object is inserted;
a plurality of electrically conductive contact members each including a contact portion and a board connection portion, the contact portion being configured to come in electrical contact with a contact provided on the connection object inserted in the slot, the board connection portion being connectable to an electrode of the board, the plurality of contact members being held by the housing member;
an electrical conductive shell member to visibly and at least partially cover the board connection portion of at least one of the plurality of contact members in a direction intersecting a mounting surface of the board; and
an electrically conductive cover member including an opening, the cover member being movably attached to the shell member between a first position and a second position, the first position allowing the board connection portion of the at least one contact member to be visually recognized through the opening, the second position preventing the board connection portion of the at least one contact member from being visually recognized through the opening.

### BRIEF DESCRIPTION OF DRAWINGS

A more complete understanding of this application can be obtained when the following detailed description is considered in conjunction with the following drawings, in which:

FIG. 1 is a perspective view of an electrical connector, a board, and a card according to an embodiment of the present disclosure;

FIG. 2A is a diagram illustrating arrangement of electrodes on the board;

FIG. 2B is a top view of one surface (a lower surface) of the card near contacts;

FIG. 2C is a top view of the other surface (an upper surface), opposite to the one surface, of the card near the contacts;

FIG. 3 is a perspective view of the electrical connector illustrated in FIG. 1;

FIG. 4A is a perspective view illustrating arrangement of contact members and fixing members;

FIG. 4B is a perspective view illustrating a connection state between the contact members and a plate-shaped connection object;

FIG. 4C is a perspective view of a housing member and the contact members;

FIG. 5 is an exploded perspective view of the electrical connector;

FIG. 6A is a perspective view illustrating a structure of a receiving portion in a shell member;

FIG. 6B is a rear view of the shell member;

FIG. 6C is a front view of the shell member;

FIG. 6D is a perspective view of a cover member before being inserted into the receiving portions;

FIG. 7A is a perspective view of the shell member and the cover member when the cover member is at a first position;

FIG. 7B is a perspective view of a part of the shell member and the cover member when the cover member is at the first position;

FIG. 8A is a perspective view of the shell member and the cover member when the cover member is at a second position;

FIG. 8B is a perspective view of a part of the shell member and the cover member when the cover member is at the second position;

FIG. 9A is a top view of the electrical connector when the cover member is at the first position;

FIG. 9B is a top view of the electrical connector when the cover member is at the second position;

FIG. 10 is a cross-sectional view of the electrical connector, taken along an X-X line in FIG. 1, when the cover member is at the second position;

FIG. 11 is a diagram illustrating a modified example of a configuration of the electrical connector when the cover member is at the first position;

FIG. 12 is a diagram illustrating a modified example of a configuration of the electrical connector when the cover member is at the second position; and

FIG. 13 is a cross-sectional view taken along an XIII-XIII line in FIG. 12.

### DETAILED DESCRIPTION OF THE INVENTION

Hereinafter, an embodiment of the present disclosure is described in detail with reference to the drawings. In the drawings, the same or equivalent parts are designated by the same reference sign. In the following embodiment, expressions such as “having”, “including”, and “containing” include the meanings of “comprising” or “consisting of”. In the present embodiment, description is made as appropriate using a three-axis Cartesian coordinate system defined by X, Y, and Z axes illustrated in the drawings.

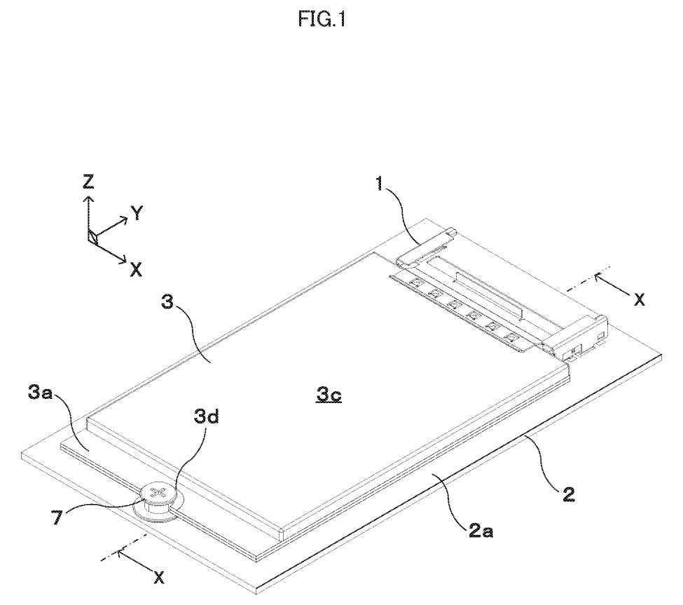

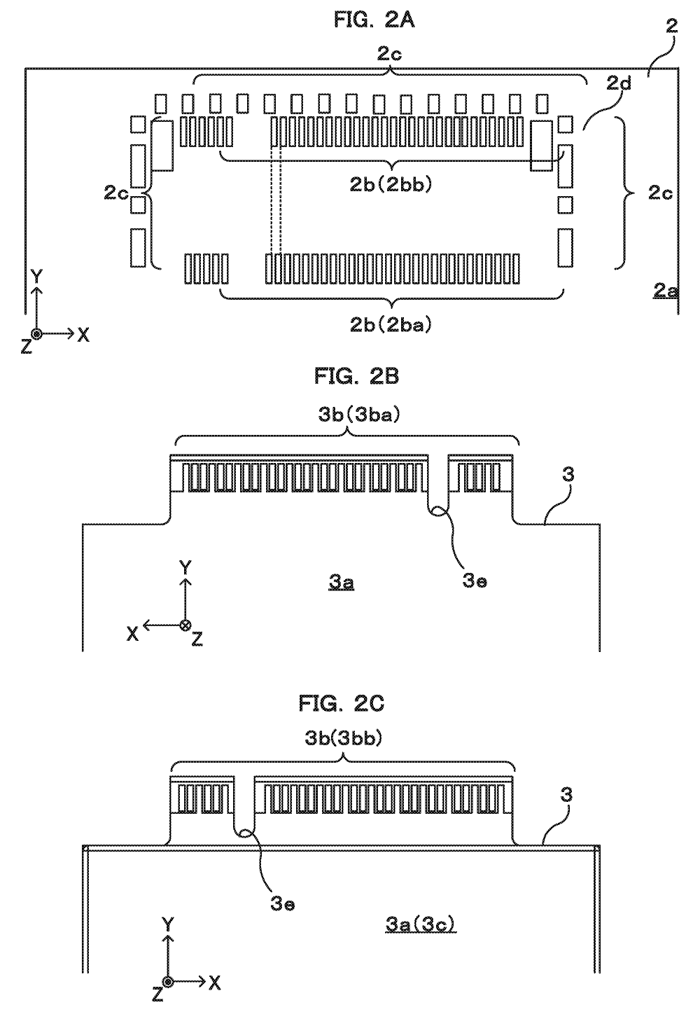

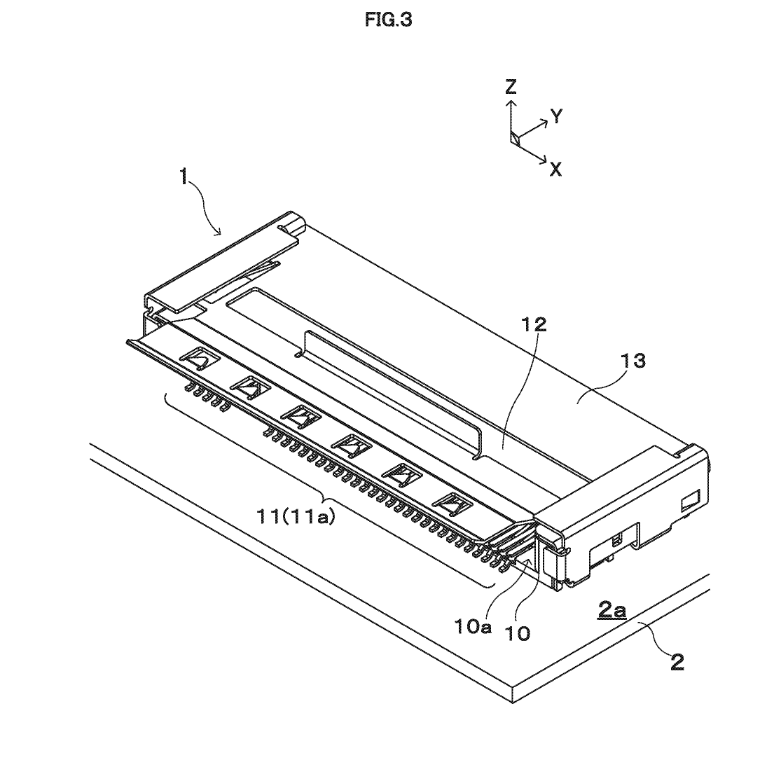

As illustrated in FIG. 1, an electrical connector 1 according to the embodiment of the present disclosure is mounted on a board 2, and electrically connects the board 2 and a card 3 that is a flat plate-shaped connection object. The electrical connector 1 is mounted on a mounting surface 2a of the board 2 by soldering or the like. As illustrated in FIG. 2A, signal electrodes 2b are provided on the mounting surface 2a of the board 2, and the electrical connector 1 is connected to the signal electrodes 2b.

In the present embodiment, the electrical connector 1 is described with reference to the three-axis Cartesian coordinate system consisting of the X, Y, and Z axes. A plane along the mounting surface 2a of the board 2 is defined as an XY plane, and a normal direction of the mounting surface 2a is defined as a Z-axis direction. As illustrated in FIG. 1, the card 3 is inserted into the electrical connector 1 along a +Y direction.

The card 3 is, for example, an M.2 card. M.2 is a standard that defines form factors and connection terminals for built-in expansion cards in computers. The card 3 includes a main body that includes front and rear wide surfaces 3a having rectangular outer edges. The main body includes a non-illustrated internal circuit such as a memory. As illustrated in FIGS. 2B and 2C, one end (an end in the +Y direction) of the main body of the card 3 includes contacts 3b that are electrodes connected to the internal circuit. The electrical connector 1 is connected to the contacts 3b to electrically connect the signal electrodes 2b of the board 2 and the contacts 3b of the card 3.

As illustrated in FIGS. 2B and 2C, the card 3 includes arrays of the contacts 3b at the end. In practice, in the card 3, the arrays of contacts 3b are formed in one row at an end of one wide surface 3a and in one row at an end of the other wide surface 3a on the reverse side. As illustrated in FIG. 2B, the contacts 3b provided on the wide surface 3a facing a −Z direction are referred to as contacts 3ba, and as illustrated in FIG. 2C, the contacts 3b provided on the wide surface 3a facing a +Z direction are referred to as contacts 3bb. An arrangement pitch of the contacts 3ba is the same as that of the contacts 3bb, and the positions of the contacts 3ba are offset by half of the arrangement pitch in an arrangement direction (an X-axis direction) relative to the positions of the contacts 3bb.

Correspondingly, as illustrated in FIG. 2A, arrays of the signal electrodes 2b having the same number and arrangement pitch as the contacts 3b of the card 3 are formed in the X-axis direction on the mounting surface 2a of the board 2. On the card 3, the arrays of the signal electrodes 2b are formed in two rows in a Y-axis direction. Specifically, corresponding to the array of the contacts 3ba, an array of signal electrodes 2ba is formed as the array of the signal electrodes 2b closer to a −Y direction, and corresponding to the array of the contacts 3bb, an array of signal electrode 2bb is formed as the array of the signal electrodes 2b closer to the +Y direction. An arrangement pitch of the respective arrays of the signal electrodes 2ba and 2bb is the same as that of the contacts 3ba and 3bb, and the positions of the signal electrodes 2ba are offset by half of the arrangement pitch in an arrangement direction (the X-axis direction) relative to the positions of the signal electrodes 2bb.

The electrical connector 1 connects the signal electrodes 2b of the board 2 and the contacts 3b of the card 3 in a one-to-one manner. As illustrated in FIG. 2A, a plurality of ground electrodes 2c are arranged in such a way as to surround the arrays of the signal electrodes 2b on the mounting surface 2a. The board 2 further includes a pair of soldering portions 2d.

### Electrical Connector

A configuration of the electrical connector 1 is described. As illustrated in FIGS. 1, 3, 4A to 4C, and 5, the electrical connector 1 includes a housing member 10, contact members 11, a shell member 12, a cover member 13, and fixing members 14.

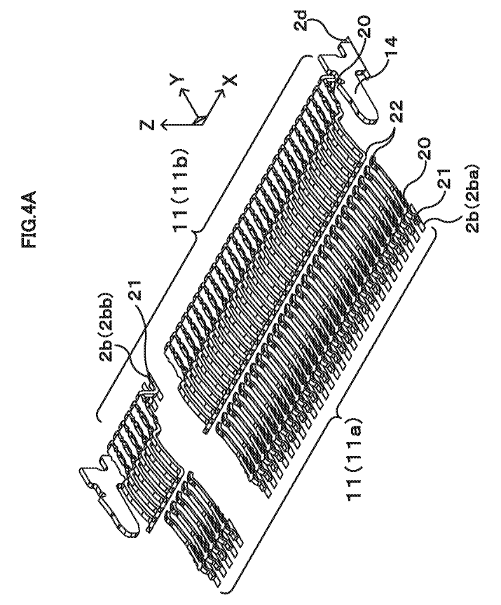

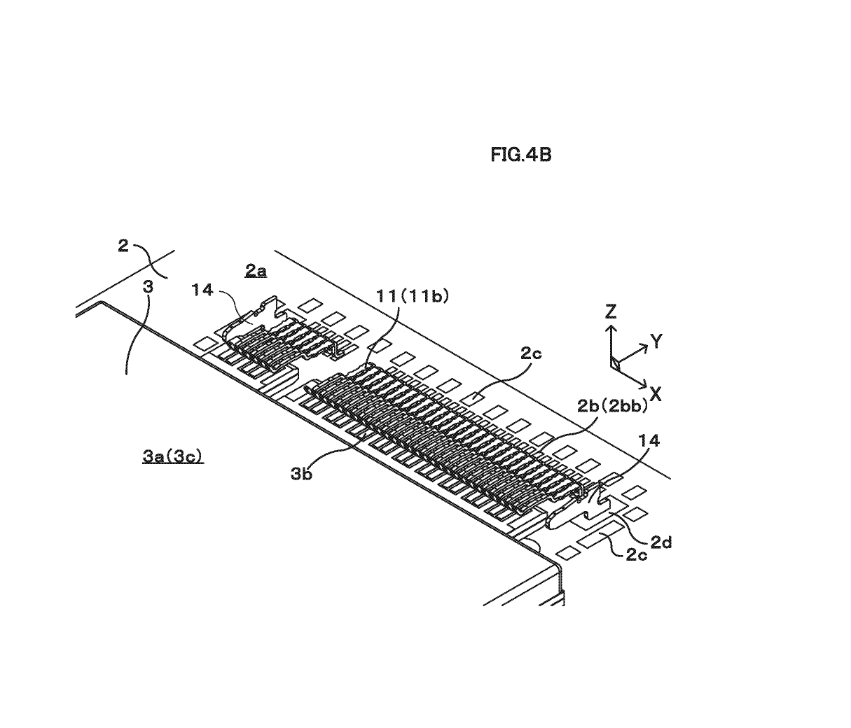

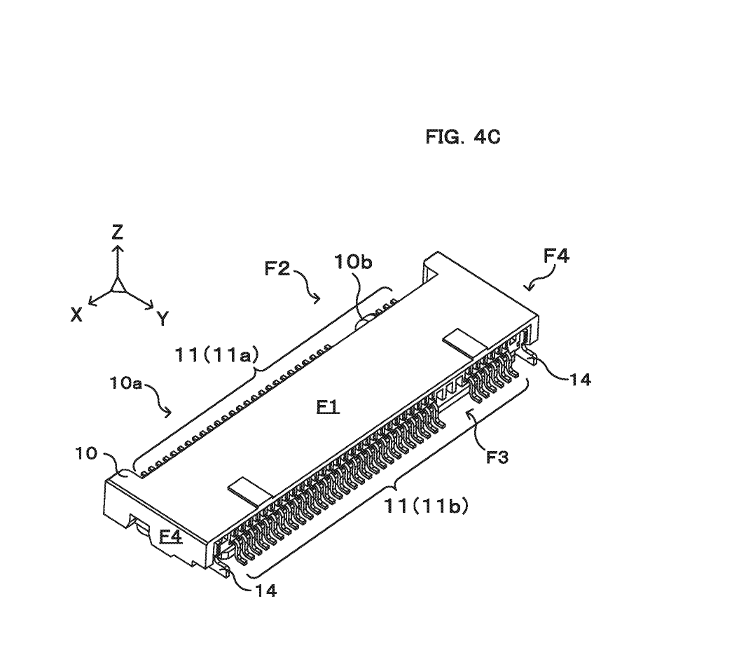

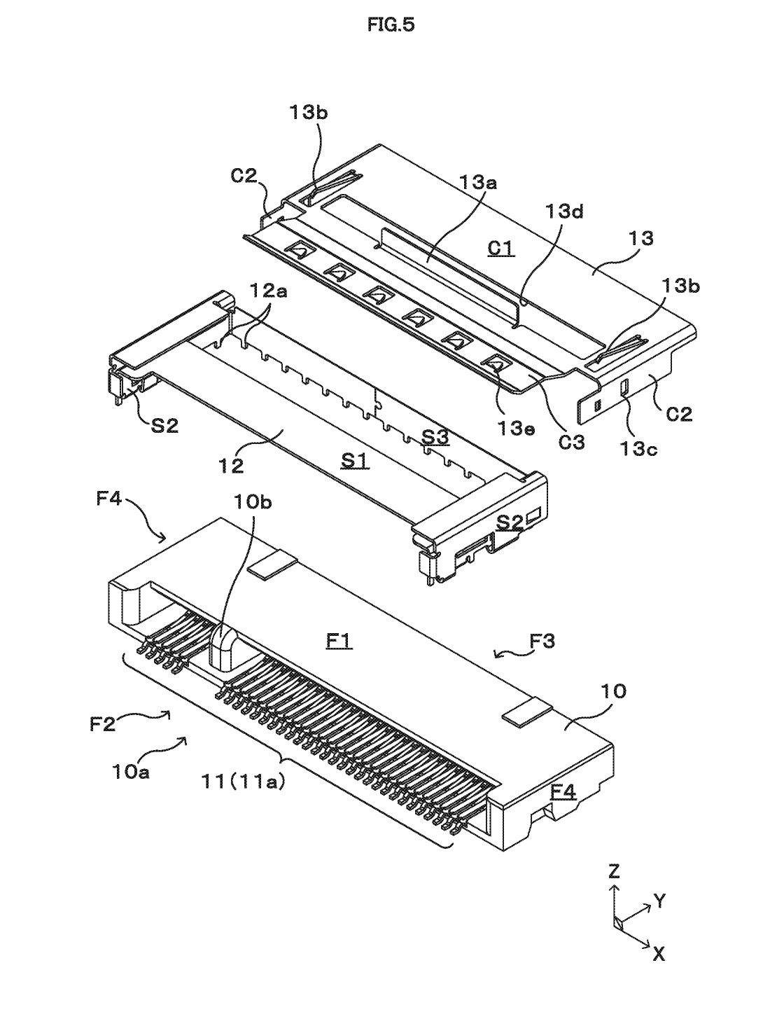

The housing member 10 is a base of the electrical connector 1, and is made of an insulating material such as resin. The housing member 10 has a substantially rectangular parallelepiped shape with the X-axis direction as its longitudinal direction. As illustrated in FIGS. 4C and 5, the housing member 10 includes a bottom surface facing the board 2, a top surface F1 opposite to the bottom surface, a front surface F2 facing the card 3, a back surface F3 opposite to the front surface F2, and two side surfaces F4 at both ends in the longitudinal direction (the X-axis direction).

As illustrated in FIGS. 4C and 5, the housing member 10 is mounted on the board 2 in such a way that the front surface F2 faces the −Y direction. The front surface F2 of the housing member 10 includes a slot 10a into which the one end of the card 3 including the contacts 3b is inserted. As illustrated in FIG. 1, the card 3 is inserted into the slot 10a with the wide surface 3a facing the mounting surface 2a of the board 2. In this case, the wide surface 3a facing the mounting surface 2a needs to be the wide surface 3a including the contacts 3ba. Therefore, a mechanism is provided that prevents the card 3 from being inserted into the slot 10a with the wide surface 3a including the contacts 3bb facing the mounting surface 2a.

As illustrated in FIGS. 2B and 2C, the one end of the card 3 including the contacts 3b is provided with a slit 3e. The slit 3e is formed at a position offset from the center of the card 3 in the X-axis direction. Meanwhile, the slot 10a of the housing member 10 includes a partition portion 10b. The partition portion 10b is formed corresponding to the position of the slit 3e in the X-axis direction. Since the slit 3e is formed offset from the center of the card 3, when the front and back of the card 3 are reversed, the position of the slit 3e does not match the position of the partition portion 10b, and the one end of the card 3 comes in contact with the partition portion 10b, thereby preventing the card 3 from being inserted into the slit 10a.

The contact members 11 are terminals that electrically connect the signal electrodes 2b of the board 2 and the contacts 3b of the card 3. The contact members 11 are made of an electrically conductive material such as metal. Specifically, the contact members 11 are formed by, for example, punching a metal plate. As illustrated in FIG. 4A, each of the contact members 11 includes a locking portion 20, a board connection portion 21, and a contact portion 22. Although illustration of the housing member 10 is omitted in FIG. 4A for ease of understanding, in practice, the locking portion 20 is locked to the housing member 10. In this manner, the contact members 11 are held by the housing member 10. The board connection portion 21 is connected to the signal electrode 2b of the board 2 by soldering or the like. The contact portion 22 comes in electrical contact with the contact 3b provided on the card 3 inserted in the slot 10a. The contacts 3b of the card 3 and the signal electrodes 2b of the board 2 are electrically connected to each other via the contact members 11.

As illustrated in FIG. 4A, the electrical connector 1 includes the plurality of contact members 11. The plurality of contact members 11 are arranged in the X-axis direction, corresponding to the arrays of the contacts 3b of the card 3 and the arrays of the signal electrodes 2b of the board 2. The arrays of the contact members 11 in the X-axis direction are formed in two rows aligned in the Y-axis direction. The number of the contact members 11 in each row is the same as the number of the contacts 3ba and 3bb in the arrays of the contacts 3ba and 3bb on the card 3, and the arrangement pitch of the contact members 11 is also the same as that of the arrays of contacts 3ba and 3bb. Further, the positions of the contact members 11 (11a and 11b) in the X-axis direction in each row are also offset by half of the arrangement pitch, similarly to relationship between the arrangement pitches of the signal electrodes 2ba and 2bb and the contacts 3ba and 3bb.

As illustrated in FIG. 4A, among the contact members 11, the contact members 11 in the row closer to the −Y direction are referred to as the contact members 11a, and the contact members 11 in the row closer to the +Y direction are referred to as the contact members 11b. The contact portions 22 of the contact members 11a come in contact with the contacts 3ba (see FIG. 2B) that are the contacts 3b closer to the −Z direction on the card 3 inserted in the slot 10a. The contact portions 22 of the contact members 11b come in contact with the contacts 3bb (see FIG. 2C) that are the contacts 3b closer to the +Z direction on the card 3 inserted in the slot 10a. This provides a transmission path from the contacts 3ba disposed closer to the −Z direction and inserted in the slot 10a via the contact members 11a to the signal electrodes 2ba, and a transmission path from the contacts 3bb disposed closer to the +Z direction and inserted in the slot 10a via the contact members 11b to the signal electrodes 2bb.

As illustrated in FIGS. 1 and 2C, the surface of the card 3 including the contacts 3bb is provided with a shield case 3c serving as an electromagnetic wave shield that covers the non-illustrated internal circuit to prevent electromagnetic waves from entering from the outside. The shield case 3c is made of an electrically conductive material such as metal.

As illustrated in FIG. 1, the other end (an end in the −Y direction) of the card 3 includes a semi-circular notch 3d described later. The card 3 is fixed to the board 2 at the notch 3d with a bolt 7. As a result, the card 3 is substantially parallel to the mounting surface 2a of the board 2.

### Shell Member

As illustrated in FIG. 5, the shell member 12 is made of an electrically conductive material such as metal. The shell member 12 is formed by, for example, bending a metal plate cut into a predetermined shape. The shell member 12 at least partially covers the housing member 10. Specifically, the shell member 12 covers the top surface F1, the back surface F3, and the side surfaces F4 of the housing member 10, and is connected to the board 2. The shell member 12 may cover portions of the front surface F2 at both ends in the X-axis direction.

As illustrated in FIG. 5, the shell member 12 includes a top surface portion S1 disposed facing the top surface F1 of the housing member 10, side surface portions S2 continuous with the top surface portion S1 and disposed facing the side surfaces F4 of the housing member 10, and a back surface portion S3 continuous with the side surface portions S2 and disposed facing the back surface F3 of the housing member 10. The top surface portion S1 covers a part of the top surface F1 of the housing member 10. The side surface portions S2 cover the side surfaces F4 of the housing member 10. The back surface portion S3 covers the back surface F3 of the housing member 10.

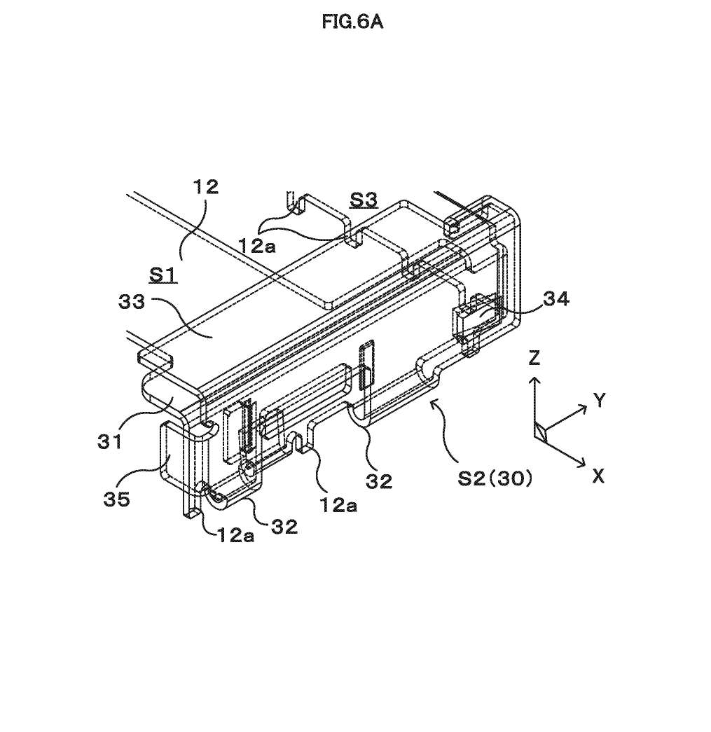

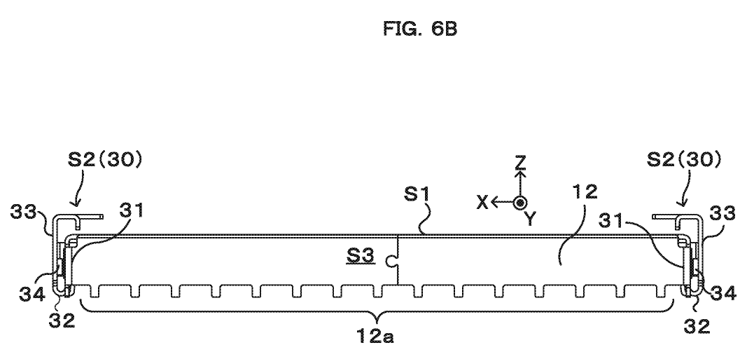

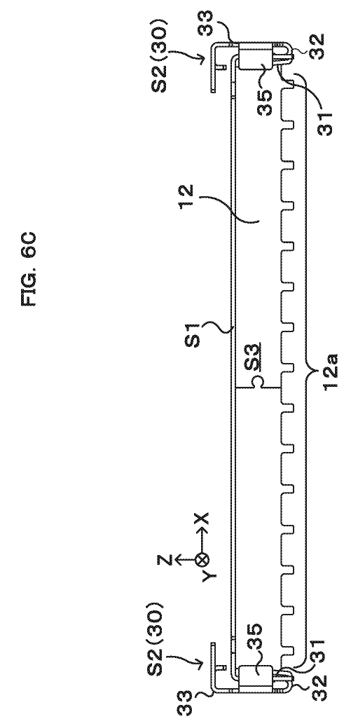

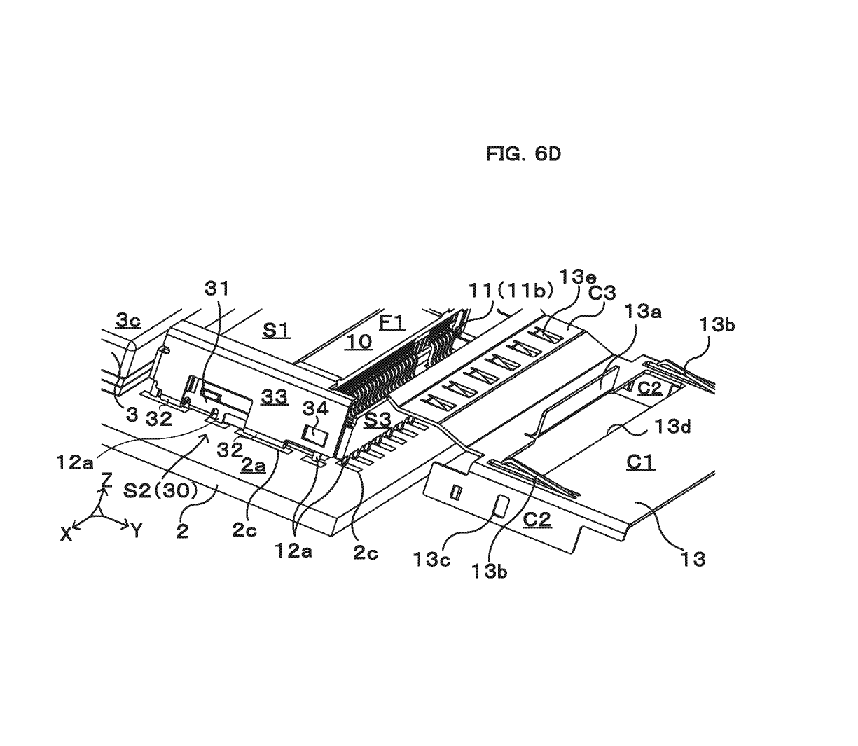

As illustrated in FIGS. 5 and 6A to 6D, the side surface portions S2 and the back surface portion S3 include board connection portions 12a that are connected to the ground electrodes 2c of the board 2. When the board connection portions 12a are connected to the ground electrodes 2c, the shell member 12 has the same potential as the ground electrodes 2c of the board 2. Since the ground electrodes 2c are arranged in such a way as to surround the signal electrodes 2b as illustrated in FIG. 2A, the board connection portions 12a of the shell member 12 are also arranged in such a way as to surround the signal electrodes 2b and the contact members 11 connected thereto along the XY plane.

The shell member 12, with the top surface portion S1, the side surface portions S2, and the back surface portion S3, covers the top surface F1, the back surface F3, and the side surfaces F4 of the housing member 10 in the electrical connector 1 to function as a electromagnetic wave shield that suppresses intrusion of electromagnetic waves from the outside and leakage of electromagnetic waves generated inside. The back surface portion S3 includes a pair of flat plate-shaped portions bent from ends of the pair of side surface portions S2 in the +Y direction toward the center of the shell member 12 in the X-axis direction. Tips of the pair of flat plate-shaped portions engage at the center of the shell member 12 in the X-axis direction to form the back surface portion S3.

A gap is provided between the back surface portion S3 and the top surface portion S1. This gap allows the board connection portion 21 of at least one of the plurality of contact members 11 to be visually recognized in a direction intersecting the mounting surface 2a of the board 2. The configuration of the back surface portion S3 bent from the side surface portions S2 can increase the gap to facilitate confirmation of a soldering state between the board connection portion 21 of the contact member 11b and the signal electrode 2bb by visual inspection or the like from the outside. The configuration of the back surface portion S3 bent from the side surface portions S2 also can reduce a gap that is likely to occur at corners of boundaries among the top surface portion S1, the side surface portions S2, and the back surface portion S3 of the shell member 12 formed by bending.

As illustrated in FIGS. 6A, 6B, and 6C, each of the side surface portions S2 is formed in a double-layered structure by bending a plate-like portion. Thus, as illustrated in FIG. 6D, the double-layered portions can receive the cover member 13. Hereinafter, the portions that receive the cover member 13 are referred to as receiving portions 30.

As illustrated in FIGS. 6B and 6C, the receiving portions 30 are formed by bending plate-like portions extending from both ends of the top surface portion S1 in the X-axis direction. Each of the receiving portions 30 includes an inner plate portion 31, a coupling portion 32, and an outer plate portion 33. The inner plate portion 31 is connected to one of the ends of the top surface portion S1 in the X-axis direction, and is bent in the −Z direction. The coupling portion 32 is connected to an end of the inner plate portion 31 in the −Z direction, and is a bottom surface of the receiving portion 30 that is bent outward in the X-axis direction around the Y axis. The outer plate portion 33 is connected to a portion of the connecting portion 32 opposite to a portion thereof connected to the inner plate portion 31, and is a plate-like portion that extends in the +Z direction with a space from the inner plate portion 31. An end of the outer plate portion 33 in the +Z direction is bent toward the center of the shell member 12 in the X-axis direction. A part of the cover member 13 is inserted between the inner plate portion 31 and the outer plate portion 33.

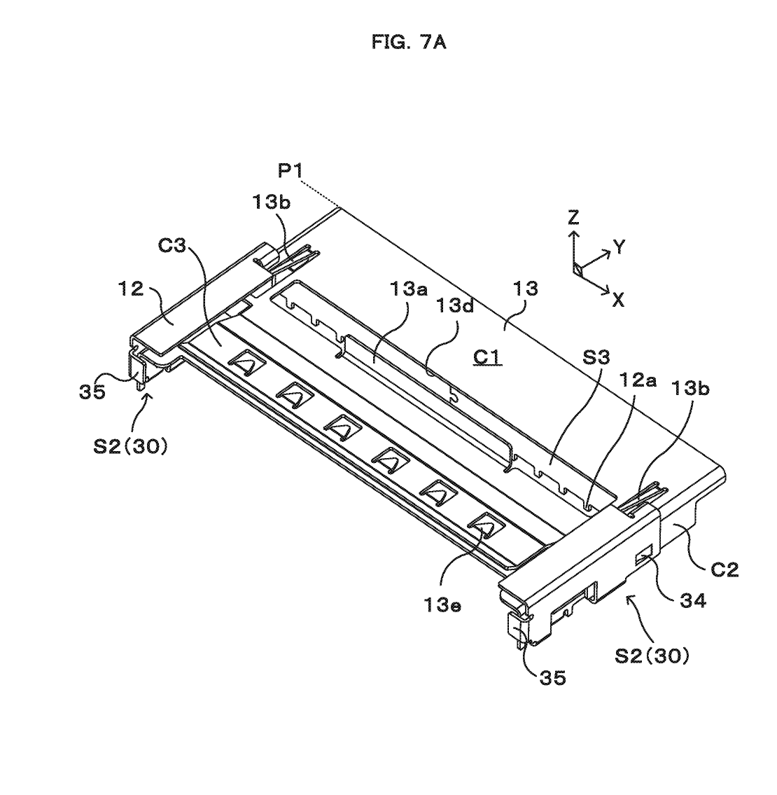

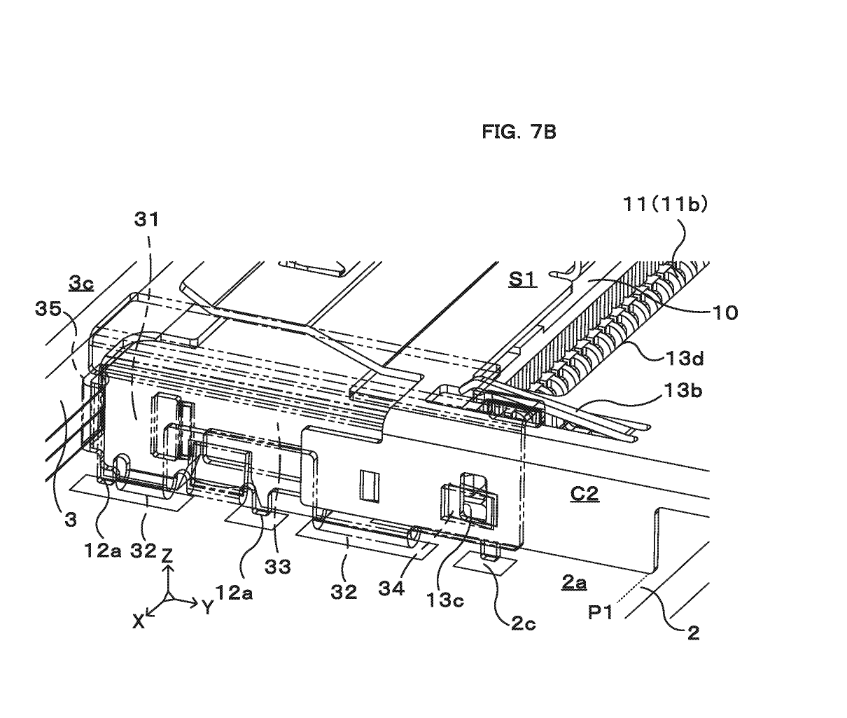

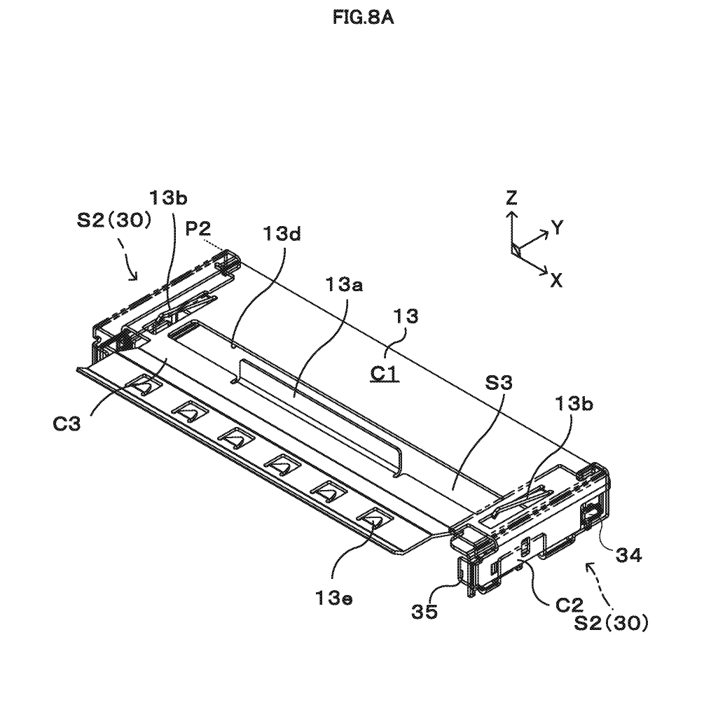

A portion of the outer plate portion 33 closer to the +Y direction includes a first restriction portion 34. The first restriction portion 34 is a protruding portion formed in the receiving portion 30. Specifically, the first restriction portion 34 is formed by leaving only an edge of the outer plate portion 33 closer to the −Y direction, cutting the rest to form a rectangular piece, and bending the rectangular piece toward the inner plate portion 31 about the edge closer to −Y direction as an axis. In the first restriction portion 34, the protruding portion fits into a through hole 13c described later in the cover member 13 inserted into the receiving portion 30, and restricts further movement of the cover member 13 in the +Y direction. The position of the cover member 13 relative to the shell member 12 when the cover member 13 is restricted by the first restriction portion 34 is defined as a first position P1 (see FIGS. 7A and 7B).

In other words, the first restriction portion 34 restricts movement of the cover member 13 inserted in the receiving portion 30 of the shell member 12 beyond the first position P1 in a direction toward the first position P1 (in the +Y direction).

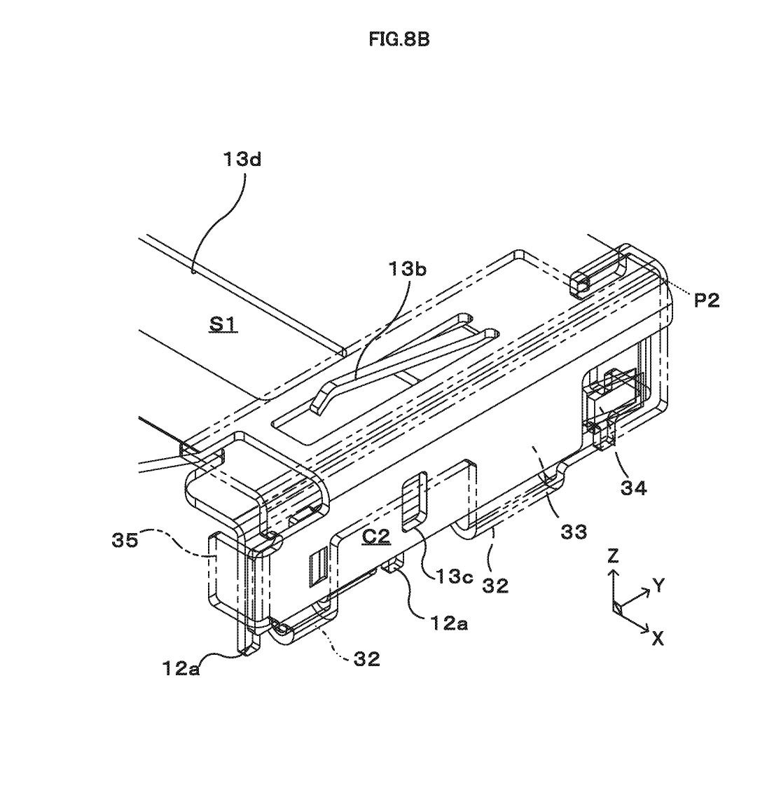

As illustrated in FIGS. 6A and 6C, an end of the outer plate portion 33 in the −Y direction is connected to a second restriction portion 35. The second restriction portion 35 extends from the outer plate portion 33 toward the inner plate portion 31. The second restriction portion 35 comes in contact with the cover member 13 inserted in the receiving portion 30, and restricts further movement of the cover member 13 in the −Y direction. The position of the cover member 13 relative to the shell member 12 when the cover member 13 is restricted by the second restriction portion 35 is defined as a second position P2 (see FIGS. 8A and 8B).

In other words, the second restriction portion 35 restricts movement of the cover member 13 inserted in the receiving portion 30 of the shell member 12 beyond the second position P2 in a direction toward the second position P2 (in the −Y direction).

### Cover Member

The cover member 13 is made of an electrically conductive material such as metal. As illustrated in FIG. 5, the cover member 13 is formed by, for example, bending a metal plate cut into a predetermined shape. The cover member 13 includes a top surface portion C1, two side surface portions C2 that are continuous with both edge portions of the top surface portion C1 in the X-axis direction and are bent to extend in the −Z direction, and a protruding portion C3 that is continuous with an edge portion of the top surface portion C1 in the −Y direction and protrudes in the −Y direction.

The top surface portion C1 of the cover member 13 includes a knob 13a. The knob 13a is provided as an operating portion to be grasped with a finger or the like to insert the side surface portions C2 of the cover member 13 into the receiving portions 30 of the shell member 12 from the −Y direction and slide the cover member 13 in the Y-axis direction, as illustrated in FIG. 6D.

The shell member 12 includes contact surfaces of the outer plate portions 33 (surfaces of the outer plate portions 33 facing the −Z direction and surfaces of the connection portions 32 facing the +Z direction) capable of coming in contact with the cover member 13 at both ends in the Z-axis direction. The cover member 13 includes second ground contact portions 13b that come in contact with the contact surfaces while maintaining an elastic state in the Z-axis direction. When the side surface portions C2 are inserted into the receiving portions 30, the second ground contact portions 13b come in contact with the contact surfaces of the outer plate portions 33 while maintaining the elastic state. Specifically, the second ground contact portions 13b are elastically supported by the cover member 13, and displace within a range of elastic deformation to maintain electrical contact with the outer plate portions 33 of the shell member 12. In other words, the second ground contact portions 13b maintain the electrical contact with the outer plate portions 33 of the shell member 12 while maintaining the elastic state. Since the second ground contact portions 13b come in contact with the shell member 12 while maintaining the elastic state, the cover member 13 is constantly pressed against the shell member 12 in the −Z direction. This can stabilize the position of the cover member 13 in the Z-axis direction.

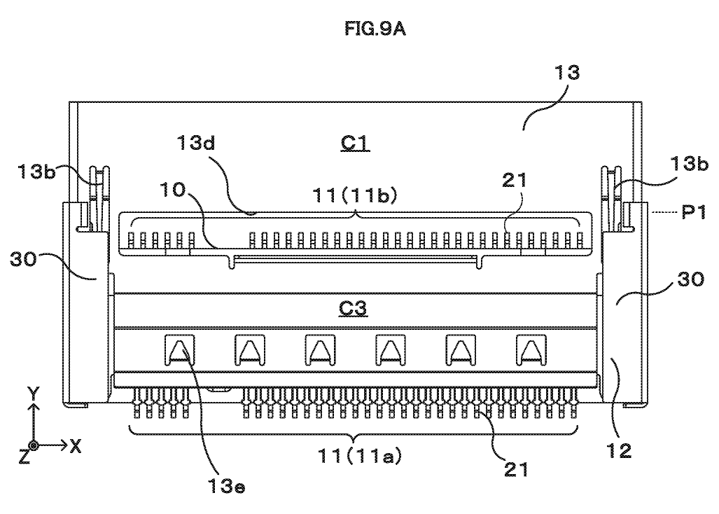

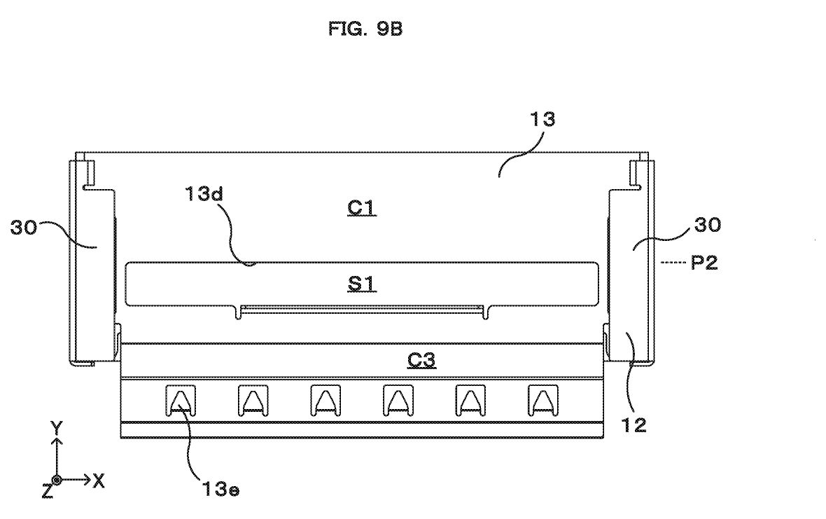

When the side surface portions C2 are inserted into the receiving portions 30, the top surface portion C1, together with the top surface portion S1 of the shell member 12, covers the top surface F1 of the housing member 10. The cover member 13 is movably attached to the shell member 12 between the first position P1 illustrated in FIGS. 7A and 7B (see FIG. 9A) and the second position P2 illustrated in FIGS. 8A and 8B (see FIG. 9B). By operating the knob 13a, the cover member 13 can be moved in a direction (the Y-axis direction) parallel to a surface of the shell member 12 orthogonal to the normal direction (the Z-axis direction) of the mounting surface 2a of the board 2.

Each of the side surface portions C2 of the cover member 13 includes a through hole 13c. When the cover member 13 is at the first position P1 as illustrated in FIG. 7A, the first restriction portion 34 of the shell member 12 enters the through hole 13c of the cover member 13 as illustrated in FIG. 7B. This restricts further movement of the cover member 13 in the +Y direction. As illustrated in FIG. 8A, when the cover member 13 is at the second position P2, the second restriction portion 35 of the shell member 12 is in contact with an end of the cover member 13 in the −Y direction. This restricts further movement of the cover member 13 in the −Y direction. As illustrated in FIG. 8B, when the cover member 13 is at the second position P2, the first restriction portion 34 of the shell member 12 is in contact with an edge portion of the side surface portion C2 of the cover member 13 in the +Y direction. This also restricts movement of the cover member 13 in the +Y direction, and fixes the cover member 13 at the second position P2 (see FIG. 9B).

The top surface portion C1 of the cover member 13 includes an opening 13d that is a rectangular through hole. In other words, the opening 13d is formed on a surface orthogonal to the Z-axis direction. When the cover member 13 is at the first position P1, the opening 13d is positioned facing the board connection portions 21 of the contact members 11b. As a result, as illustrated in FIG. 9A, a connection state between the board connection portions 21 of the contact members 11b and the signal electrodes 2bb, that is, a soldering state therebetween can be confirmed through the opening 13d. As illustrated in FIG. 9B, when the cover member 13 is at the second position P2, the opening 13d is positioned on the top surface portion S1 of the shell member 12. This prevents the board connection portions 21 of the contact members 11b from being visually recognized through the opening 13d, and thereby shields electromagnetic waves.

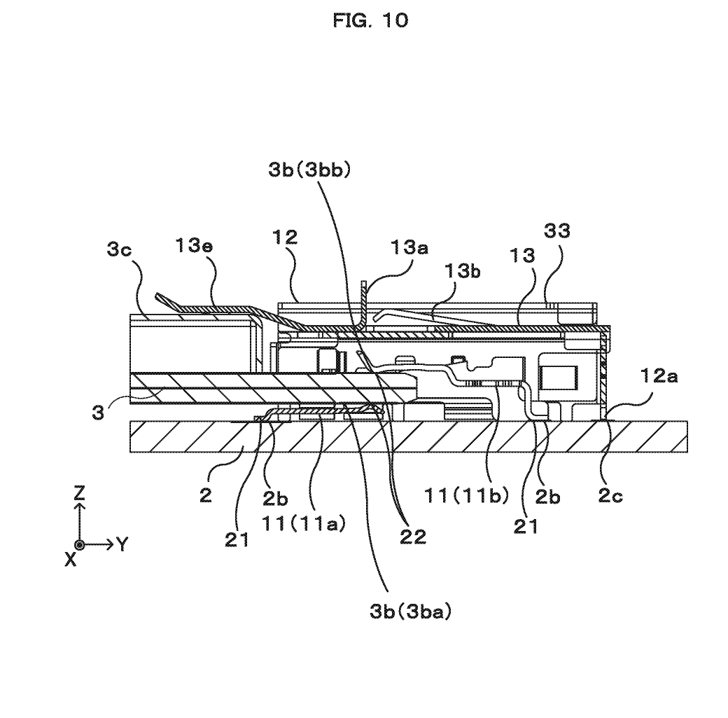

The protruding portion C3 of the cover member 13 includes a plurality of first ground contact portions 13e. When the cover member 13 moves from the first position P1 to the second position P2, the first ground contact portions 13e protrude in the −Y direction. When the cover member 13 is at the second position P2, the first ground contact portions 13e are in contact with the shield case 3c provided on an outer surface of the connection object inserted in the slot 10a while maintaining an elastic state, as illustrated in FIG. 10. Specifically, the first ground contact portions 13e are elastically supported by the cover member 13, and displace within a range of elastic deformation to maintain electrical contact with the shield case 3c. In other words, the first ground contact portions 13e maintain the electrical contact with the shield case 3c while maintaining the elastic state.

As illustrated in FIGS. 4A, 4B, and 4C, the fixing members 14 are held by the housing member 10 while being respectively disposed at both ends of the array of the contact members 11. The fixing members 14 are soldered to the soldering portions 2d of the board 2. This fixes the electrical connector 1 to the board 2.

As described above, the electrical connector 1 includes the housing member 10, the contact members 11, the shell member 12, the cover member 13, and the fixing members 14, and electrically connects the signal electrodes 2b of the board 2 and the contacts 3b of the card 3.

Next, a process of mounting the electrical connector 1 on the board 2 and a connection operation of the card 3 are described.

### Mounting Process

First, the electrical connector 1 is mounted on the board 2 by soldering. By soldering, the board connection portions 21 of the contact members 11 are connected to the signal electrodes 2b of the board 2, the board connection portions 12a of the shell member 12 are connected to the ground electrodes 2c of the board 2, and the fixing members 14 are connected to the soldering portions 2d of the board 2. The housing member 10 with the contact members 11 and the fixing members 14 attached thereto as illustrated in FIG. 4C is mounted on the board 2. After the housing member 10 is mounted, the shell member 12 with the cover member 13 attached thereto is attached to the housing member 10, and the board connection portions 12a of the shell member 12 and the fixing members 14 are mounted on the board 2. At this stage, the cover member 13 is at the first position P1 as illustrated in FIG. 9A. Since the card 3 has not yet been inserted at this stage, a connection state between the board connection portions 21 of the contact members 11a and the signal electrodes 2b of the board 2 can be confirmed. Further, the connection state between the board connection portions 21 of the contact members 11b and the signal electrodes 2b of the board 2 can be confirmed through the opening 13d. When these connection states are confirmed to be proper, the mounting process is completed.

### Connection Operation

The card 3 is then inserted into the slot 10a. In this state, even when the card 3 is inserted parallel to the mounting surface 2a of the board 2, elasticity of the contact members 11 causes the card 3 to incline in such a way that an end opposite to an end inserted into the slot 10a is lifted away from the board 2. Therefore, as illustrated in FIG. 1, the card 3 is fixed to the board 2 with the bolt 7 at the notch 3d formed therein. As a result, the card 3 is substantially parallel to the mounting surface 2a of the board 2.

From this state, the cover member 13 is moved from the first position P1 illustrated in FIG. 9A to the second position P2 illustrated in FIG. 9B. The cover member 13 comes in contact with the shell member 12 via the second ground contact portions 13b while maintaining the elastic state, and comes in contact with the shield case 3c of the card 3 via the first ground contact portions 13e. At this time, the shell member 12 is connected to the ground electrodes 2c of the board 2, and the ground electrodes 2c, the shell member 12, the cover member 13, and the shield case 3c thus have the same potential (for example, 0). As illustrated in FIG. 10, the shell member 12 and the cover member 13 cover the internal circuit of the card 3 and the transmission paths including the contact members 11 and the signal electrodes 2b of the electrical connector 1, and thus function as electromagnetic wave shields that shield electromagnetic waves generated by these components.

To remove the card 3 from the electrical connector 1, it is sufficient to detach the bolt 7 from the board 2, return the cover member 13 from the second position P2 to the first position P1, and detach the bolt 7 from the board 2. As a result, the elasticity of the contact members 11 causes the card 3 to rotate and become inclined with respect to the board 2. In this state, the card 3 can be easily removed from the electrical connector 1. The card 3 can be removed from the electrical connector 1 even when the cover member 13 is not returned from the second position P2 to the first position P1 and remains at the second position P2.

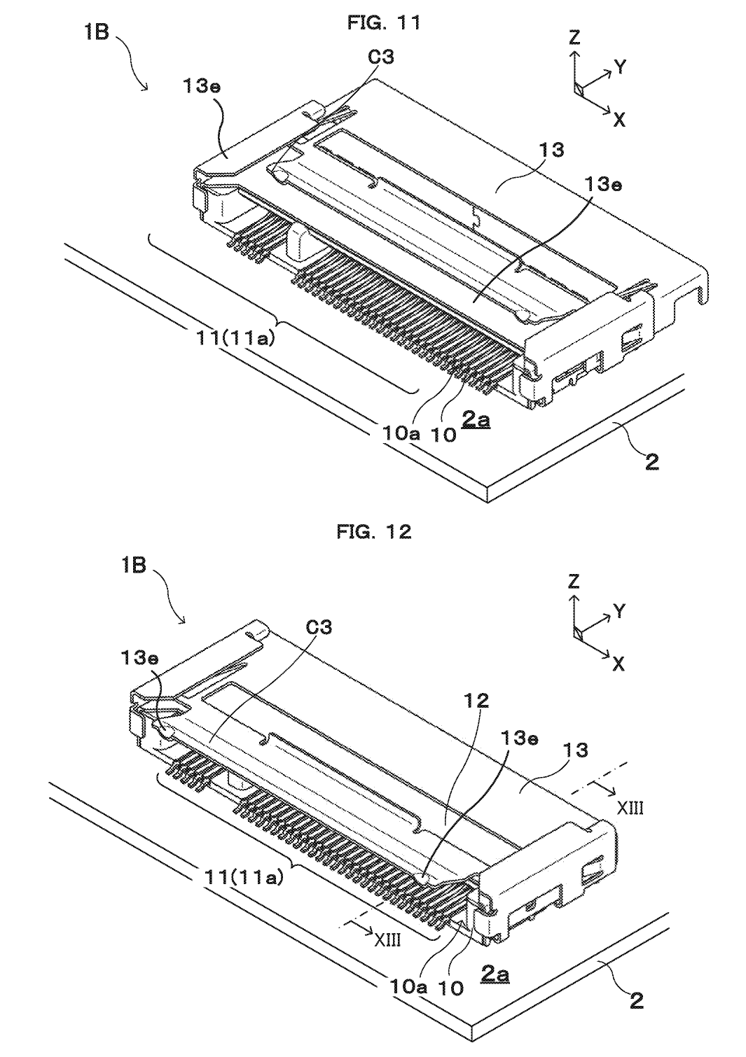

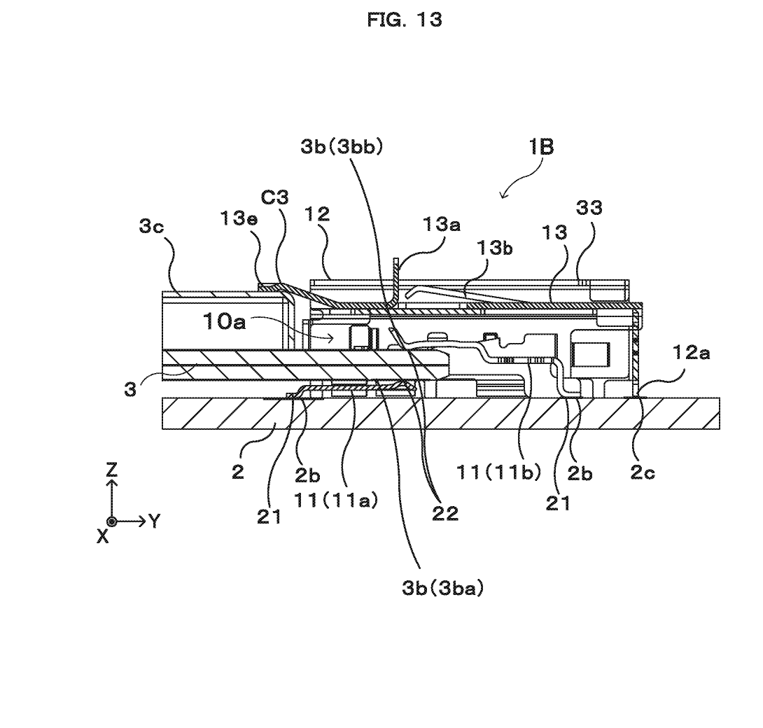

FIGS. 11 and 12 illustrate examples of a configuration of an electrical connector 1B. As illustrated in FIGS. 11 and 12, the electrical connector 1B differs from the electrical connector 1 in the shape of the cover member 13. As can be seen by comparing FIGS. 10 and 13, in the cover member 13 of the electrical connector 1B, the length of the protruding portion C3 in the Y-axis direction is shorter than that in the electrical connector 1.

As illustrated in FIGS. 11 and 12, in the electrical connector 1B, the first ground contact portions 13e are formed by concaving, in the −Z-axis direction, a part of an end of the protruding portion C3 in the −Y-axis direction. The first ground contact portions 13e are formed one at each end in the X-axis direction. When the cover member 13 is at the second position P2 as illustrated in FIG. 12, the first ground contact portions 13e are in contact with the shield case 3c provided on the outer surface of the connection object inserted in the slot 10a, as illustrated in FIG. 13.

As described above, in the electrical connector 1B, the first ground contact portions 13e are configured not as elastic members extending in the Y-axis direction, but as portions protruding in the −Z direction. This can shorten the length of the protruding portion C3 in the Y-axis direction. Shortening the length of the protruding portion C3 in the Y-axis direction allows the card 3 to be inserted into the slot 10a from an obliquely upward direction relative to the board 2, thereby facilitating insertion of the card 3. This improves workability when inserting the card 3.
(1) As described in detail above, the electrical connector 1 according to the above-described embodiment is mounted on the board 2. The electrical connector 1 includes the insulating housing member 10, the plurality of electrically conductive contact members 11, the electrically conductive shell member 12, and the electrically conductive cover member 13. The housing member 10 includes the slot 10a into which the flat plate-shaped card 3 is inserted. The electrically conductive contact members 11 are held by the housing member 10, and include the contact portions 22 that come in electrical contact with the contacts 3b provided on the card 3 inserted in the slot 10a, and the board connection portions 21 that are connected to the signal electrodes 2b of the board 2. The shell member 12 visibly and at least partially covers the board connection portion 21 of at least one of the plurality of contact members 11 in the direction intersecting the mounting surface 2a of the board 2. The cover member 13 includes the opening 13d, and is movably attached to the shell member 12 between the first position P1 (see FIGS. 7A, 7B, and 9A) that allows the board connection portion 21 of the at least one contact member 11 to be visually recognized through the opening 13d, and the second position P2 (see FIGS. 8A, 8B, and 9B) that prevents the board connection portion 21 of the at least one contact member 11 from being visually recognized through the opening 13d. By positioning the cover member 13 at the first position P1, the soldering state between the board connection portions 21 of the contact members 11b and the signal electrodes 2b can be confirmed. After the confirmation, by positioning the cover member 13 at the second position P2, the housing member 10 and the contact members 11 can be shielded from the external environment with the shell member 12 and the cover member 13. Thus, the connection state between the board 2 and the contact members 11 can be confirmed by visual inspection or the like without impairing the function of shielding electromagnetic waves.
(2) In the electrical connector 1 according to the above-described embodiment, the cover member 13 includes the first ground contact portions 13e that, when the cover member 13 is at the second position P2, are in contact with the electrically conductive shield case 3c provided on the outer surface of the card 3 inserted in the slot 10a. This allows the cover member 13 to have the same potential as the shield case 3c of the card 3 and function as an electromagnetic wave shield.
(3) In the electrical connector 1 according to the above-described embodiment, the cover member 13 moves in the direction parallel to the surface of the shell member 12 orthogonal to the Z-axis direction. This can keep a low height of the electrical connector 1 from the board 2.
(4) In the electrical connector 1 according to the above-described embodiment, the shell member 12 includes the first restriction portions 34 that restrict the cover member 13 from moving beyond the first position P1 in the direction toward the first position P1, and the second restriction portions 35 that restrict the cover member 13 from moving beyond the second position P2 in the direction toward the second position P2. This prevents the cover member 13 from being detached from the shell member 12.
(5) In the electrical connector 1 according to the above-described embodiment, the shell member 12 includes the contact surfaces (the surfaces of the outer plate portions 33 facing the −Z direction and the surfaces of the connection portions 32 facing the +Z direction) capable of coming in contact with the cover member 13 at both ends in a direction orthogonal to a direction in which the cover member 13 moves. The cover member 13 includes the second ground contact portions 13b that come in contact with the contact surfaces while maintaining the elastic state in the Z-axis direction. Thus, by bringing the cover member 13 and the shell member 12 in contact with each other, the cover member 13 can have the same potential as the shell member 12 and be constantly pressed against the shell member 12 in the −Z direction. This can stabilize the position of the cover member 13 in the Z-axis direction.
(6) In the electrical connector 1 according to the above-described embodiment, the opening 13d is provided on the surface orthogonal to the Z-axis direction. This allows the soldering between the board connection portions 21 of the contact members 11b and the signal electrodes 2b to be confirmed from the normal direction of the mounting surface 2a of the board 2.

In the above-described embodiment, the M.2 card is employed as the card 3. However, the card 3 is not limited thereto. The card 3 may be a card of other standards (for example, SD) or a communication card with a built-in wireless antenna.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. An electrical connector to be mounted on a board, the electrical connector comprising:
an insulating housing member including a slot into which a flat plate-shaped connection object is inserted;
a plurality of electrically conductive contact members each including a contact portion and a board connection portion, the contact portion being configured to come in electrical contact with a contact provided on the connection object inserted in the slot, the board connection portion being connectable to an electrode of the board, the plurality of contact members being held by the housing member;
an electrically conductive shell member to visibly and at least partially cover the board connection portion of at least one of the plurality of contact members in a direction intersecting a mounting surface of the board; and
an electrically conductive cover member including an opening, the cover member being movably attached to the shell member between a first position and a second position, the first position allowing the board connection portion of the at least one contact member to be visually recognized through the opening, the second position preventing the board connection portion of the at least one contact member from being visually recognized through the opening.

2. The electrical connector according to claim 1, wherein
the cover member includes a first ground contact portion to come in contact with an electrically conductive ground member when the cover member is at the second position, the ground member being provided on an outer surface of the connection object inserted in the slot.

3. The electrical connector according to claim 1, wherein
the cover member moves in a direction parallel to a surface of the shell member orthogonal to a normal direction of the mounting surface.

4. The electrical connector according to claim 1, wherein
the shell member includes
a first restriction portion to restrict movement of the cover member beyond the first position in a direction toward the first position, and
a second restriction portion to restrict movement of the cover member beyond the second position in a direction toward the second position.

5. The electrical connector according to claim 1, wherein
the shell member includes a contact surface capable of coming in contact with the cover member at both ends in a direction orthogonal to a direction in which the cover member moves, and
the cover member includes a second ground contact portion to come in contact with the contact surface while maintaining an elastic state in a normal direction of the mounting surface.

6. The electrical connector according to claim 1, wherein
the opening is provided on a surface orthogonal to a normal direction of the mounting surface.
